(19) United States
(12) Patent Application Publication
(10) Pub. No.: US 2017/0220538 A1
(43) Pub. Date: Aug. 3, 2017

(54) SMART ANNOTATION OF CONTENT ON COMPUTING DEVICES

(71) Applicant: Microsoft Technology Licensing, LLC, Redmond, WA (US)

(72) Inventors: Tucker Hatfield, Kirkland, WA (US); Michael Heyns, Seattle, WA (US); Dan Parish, Seattle, WA (US); Tyler Adams, Seattle, WA (US); Wesley Hodgson, Seattle, WA (US)

(21) Appl. No.: 15/186,345

(22) Filed: Jun. 17, 2016

Related U.S. Application Data
(60) Provisional application No. 62/288,546, filed on Jan. 29, 2016.

(51) Int. Cl. G06F 17/24; G06F 3/0488

(52) U.S. Cl. CPC G06F 17/241; G06F 3/04883

(57) ABSTRACT

Techniques for implementing smart annotation of digital content on a computing device are described in this document. In one embodiment, a method includes receiving an annotation to a document displayed in an application on a computing device. The application is in an annotation mode in which any received user input is recognized as annotations but not a part of the underlying content. The method also includes determining whether the annotation is related to an editing mark applicable to the underlying content of the document. In response to determining that the received annotation is related to an editing mark, determining an editing operation corresponding to the editing mark and performing the editing operation to the underlying content in the displayed document without exiting the annotation mode of the application.

### CROSS-REFERENCE TO RELATED APPLICATION(S)

This application claims priority to U.S. Provisional Application No. 62/288,546, filed on Jan. 29, 2016, the disclosure of which is incorporated herein in its entirety.

### BACKGROUND

Modern computing devices, such as smartphones, tablet computers, and laptops can often include a touchscreen as an input/output component. A user can interact with such computing devices via the touchscreen using a stylus, a pen, or even the user's finger. For example, a user can use a stylus to navigate through menus, paint a picture, or perform other operations via the touchscreen.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain computing devices, a reviewer can provide comments, remarks, editing marks, or other annotations to a document on a computing device using a stylus, a pen, the user's finger, or other suitable input device. For instance, a reviewer can handwrite annotations with a stylus on a touchscreen displaying a document on a tablet computer. The handwritten annotations can include, for example, “delete this sentence,” “add [a phrase], “add a space,” or other suitable editing marks. In response to receiving the annotations, the tablet computer can add and save the handwritten annotations as digital images in a layer of the document separate from the underlying content. An editor, for example, an original author of the document, can then manually edit the underlying content of the document based on the saved annotations to delete sentences, add phrases, add spaces, and/or perform other suitable editing operations.

Several embodiments of the disclosed technology can improve efficiencies of the foregoing editing process by allowing direct editing of underlying content in accordance with annotations. In one implementation, a computing device can be configured to execute an application and display underlying content of a document on an input/output component. In response to receiving a user input via, for instance, a stylus, the computing device can be configured to recognize the user input as an annotation. The computing device can also be configured to recognize the underlying content associated with the received annotation as text, images, video recordings, sound recordings, or other suitable types of data. The computing device can then determine whether one or more editing operations can be performed on the underlying content based on the annotation. In one embodiment, the application can automatically perform the one or more available operations. In other embodiments, the application can seek confirmation from the user before performing the one or more available operations. In further embodiments, the application can also be configured to perform the one or more operations upon user actuation, for example, by pressing an “Apply” button. As such, the foregoing disclosed technology can provide more efficient editing capabilities by eliminating or at least reducing manual editing by editors based on a reviewer's annotations.

### BRIEF DESCRIPTION OF THE DRAWINGS

FIG. 1 is a schematic diagram of a computing system in accordance with embodiments of the present technology.

FIG. 2 is a schematic diagram illustrating example software components of the computing device in FIG. 1.

FIGS. 3A-3K are example user interfaces illustrating operations suitable for the computing device in FIG. 1.

FIG. 4 is another example user interface illustrating certain operations suitable for the computing device in FIG. 1.

FIGS. 5A-5B are flowcharts illustrating methods of smart annotation of a document in accordance with embodiments of the disclosed technology.

FIG. 6 is a schematic diagram illustrating example hardware components of the computing device in FIG. 1.

### DETAILED DESCRIPTION

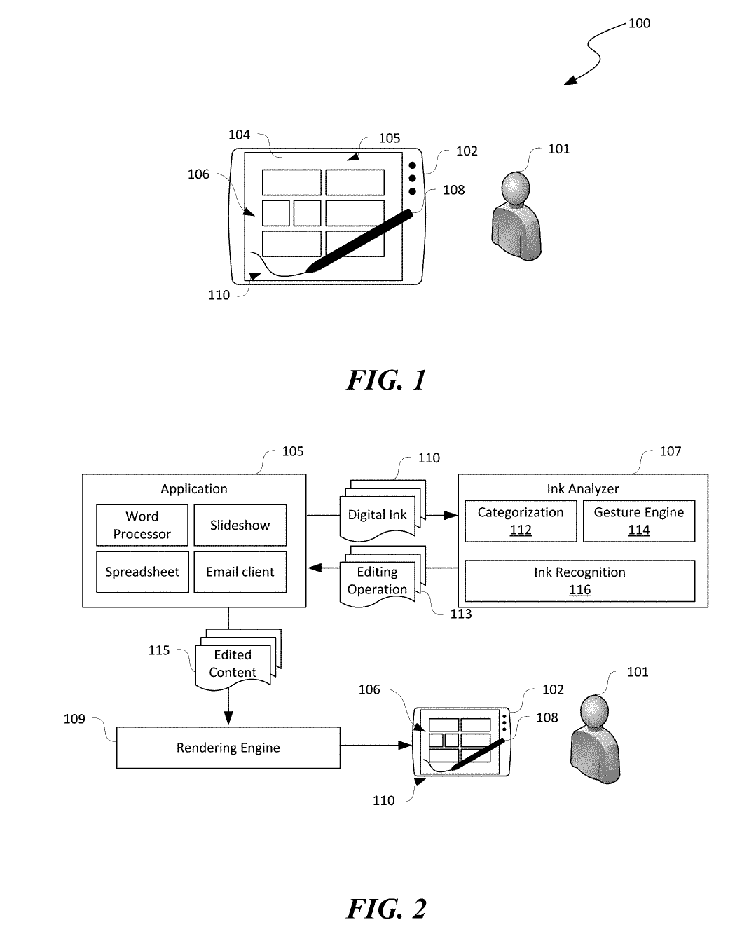

Certain embodiments of computing systems, devices, components, modules, routines, and processes for implementing smart annotation of digital content are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-4.

As used herein, the term “content” generally refers to digital data representing information useful to a user or audience. Content examples can include digital images, sound recordings, texts, video recordings, or other suitable digital media. In certain embodiments, a content file or “document” can include multiple data “layers” in which different types of media can be stored. For example, a layer of the content file can include multiple alphanumeric characters. Other layers of the content file can include digital images, sound recordings, video recordings, or other suitable types of media. The foregoing digital media are generally referred to as “underlying content” of a content file. The content file can also include other layers storing data related to authorship, publication information, security information, annotations, or other suitable information related to the underlying content of the content file.

Also used herein, the term “ink” or “digital ink” refers to digital image or other suitable types of data representing one or more strokes received at an input component (e.g., a touchscreen) of a computing device by a user utilizing a stylus, a pen, a user's finger, or other suitable pointing devices related to pen computing. A stroke or a combination of strokes can form a “gesture” with corresponding shapes, lengths, repeating patterns, or other suitable characteristics. One or more gestures can be recognized as an annotation to underlying content of a document. An “annotation” generally refers to digital data representing a note, comment, editing mark, or other suitable categories of remark associated with a content file. An annotation, however, is not a part of the underlying content of the content file. For example, a user can add an annotation that is a comment, explanation, or remark directed to the underlying content of the content file. In another example, a user can add an annotation that is an editing mark to a content file indicating, for example, that a phrase in the content file should be deleted, or a new sentence should be added to the content file. In certain embodiments, annotations can be stored with a content file as metadata of the content file. In other embodiments, the annotations can also be stored as additional content in another layer of the content file.

Further used herein, the term “editing mark” generally refers to a mark recognized as corresponding to one or more editing operations. One example editing mark can include a strike-through as a deletion mark. The term “editing operation” generally refers to an operation that alters the text file, digital images, sound recordings, video recordings, or other suitable types of media in substance or formatting in response to an editing mark. For example, an editing operation to the text file can be deleting at least a portion of the text in the text file in response to a corresponding editing mark such as a strike-through. In another example, an editing operating to a video or sound recording can include deleting a portion, changing a play speed, adding background music, or otherwise modifying the video or sound recording.

Certain editing processes involve a reviewer providing annotations in digital ink to underlying content of a document using a stylus, a pen, the user's finger, or other suitable input pointer. For instance, the reviewer can handwrite annotations with a stylus on a touchscreen displaying a document on a tablet computer. The handwritten annotations can include editing marks or general comments of critique or praise. In response to receiving the reviewer's input, the tablet computer can add and save the annotations to the displayed document, for example, as digital images. An editor can then modify the underlying content of the document based on the saved annotations to delete sentences, add phrases, add spaces, and/or perform other suitable editing operations.

The foregoing editing processes can be inefficient and burdensome by utilizing manual editing to modify the underlying content. Several embodiments of the disclosed technology can improve efficiencies of the foregoing editing process by allowing direct editing of the underlying content based on the reviewer's annotations. In certain implementations, in response to receiving an annotation, a computing device can be configured to determine whether the annotation corresponds to one or more available editing operations that can be performed on the underlying content. In response to determining that one or more editing operations are available, the computing device can automatically perform the one or more available editing operations to modify the underlying content without requiring manual editing. As such, workload on editors can be eliminated or at least reduced to improve editing efficiency, as described in more detail below with reference to FIGS. 1-4.

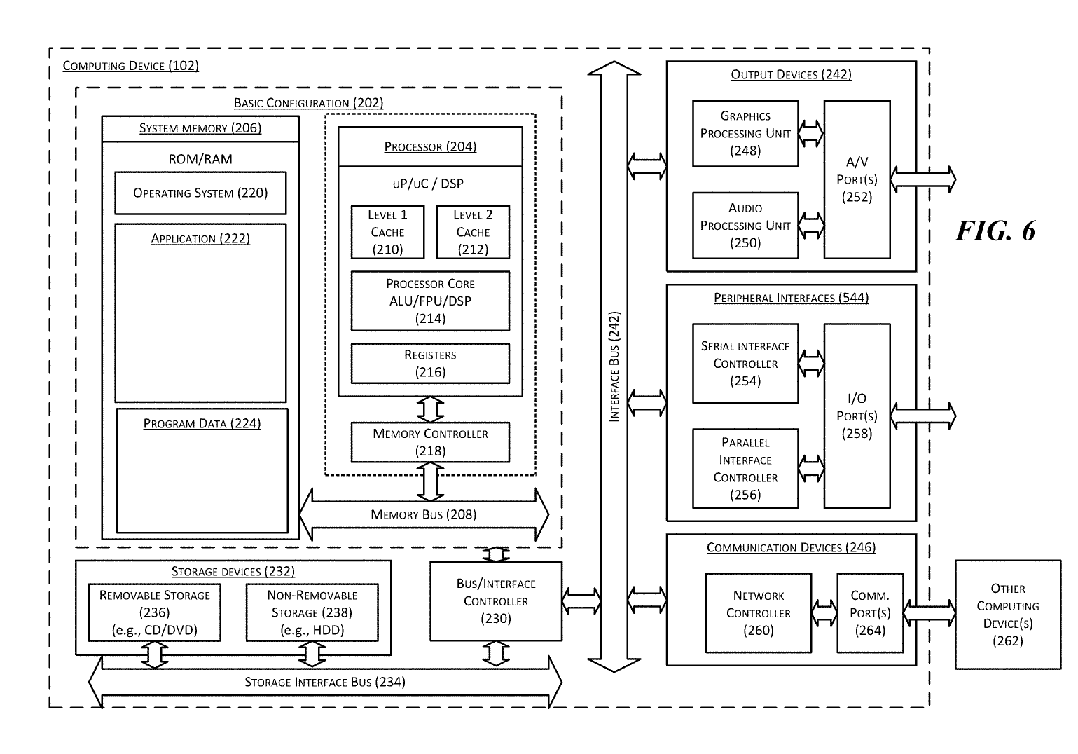

FIG. 1 is a schematic diagram of a computing system 100 in accordance with embodiments of the present technology. As shown in FIG. 1, the computing system 100 can include a computing device 102 and a pointing device 108. In the illustrated embodiment, the computing device 102 is shown as a tablet computer having a input/output component 104 (e.g., a touchscreen) and one or more processors (not shown) configured to execute an application 105 having a user interface 106. The pointing device 108 includes a stylus. In other embodiments, the computing device 102 can include a smartphone, a laptop, or other suitable devices. The pointing device 108 can include a pen, a user's finger, two or more user's fingers, or other suitable input means. One example computing device 102 is described in more detail below with reference to FIG. 6.

As shown in FIG. 1, a user 101 can utilize the pointing device 108 to interact with the application 105 via the input/output component 104, by, for example, contacting the input/output component 104 with the pointing device 108, resulting in the computing device 102 capturing digital ink 110 on the user interface 106. In certain embodiments, the digital ink 110 can include annotations that include editing marks, comments, or other suitable types of remarks related to the underlying content displayed on the user interface 106 of the application 105. In other embodiments, the digital ink 110 can also include direct editing or other suitable types of data related to the underlying content. As described in more detail below with reference to FIG. 2, the computing device 102 can detect the digital ink 110 as annotations and implement smart annotation of the underlying content in the application 105 based on the detected digital ink 110.

FIG. 2 is a schematic diagram illustrating example software components of the computing device in FIG. 1. In FIG. 2 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media that exclude propagated signals.

As shown in FIG. 2, one or more processor (shown in FIG. 6) of the computing device 102 can execute suitable instructions to provide an application 105 that is operatively coupled to an ink analyzer 107 and a rendering engine 109. Even though the foregoing components are shown as distinct from one another, in certain embodiments, at least one of the ink analyzer 107 or the rendering engine 109 can be integrated into the application 105. In further embodiments, the ink analyzer 107 and the rendering engine 109 can be integrated into a single component. In the illustrated embodiment, the application 105 can include an application of a word processor, a slideshow, a spreadsheet, or an email client. In other embodiments, the application 105 can also include a website editor, a scheduler, a journal, a web browser, or other suitable types of application.

The ink analyzer 107 can be configured to process the digital ink 110 captured on the user interface 106. As shown in FIG. 2, the ink analyzer 107 can include a categorization module 112, a gesture engine 114, and an ink recognition module 116 operatively coupled to one another. The categorization module 112 can be configured to categorize the digital ink 110 received from the user 101 into different types of annotations. For example, the categorization module 112 can be configured to recognize certain strokes as potential editing marks to the underlying content of the document because a location of the detected input is within certain bounds of the document (e.g., within margins of the document). In another example, the categorization module 112 can also be configured to recognize certain strokes as comments because locations of the detected input are outside the certain bounds of the document. For example, the strokes related to comments can be located on a margin of the document instead of a content area of the document. In further embodiments, the categorization module 112 can categorize the digital ink 110 in other suitable manners.

The gesture engine 114 can be configured to determine a gesture that corresponds to one or more strokes of the digital ink 110 received from the user 101. In certain embodiments, the gesture engine 114 can include routines that calculate a length, angle, variation, shape, or other suitable parameters of the strokes and correlate the calculated parameters to a gesture based on, for example, a gesture database (not shown). For example, the gesture engine 114 can recognize a stroke as a strike-through gesture when the stroke extends longitudinally for a length with limited variation along the vertical direction. In another example, the gesture engine 114 can correlate a stroke to a check mark when the stroke reverses a direction of extension at certain angles (e.g., about 30° to about 90°). In other embodiments, the gesture engine 114 can be configured to recognize the gesture by implementing other suitable techniques.

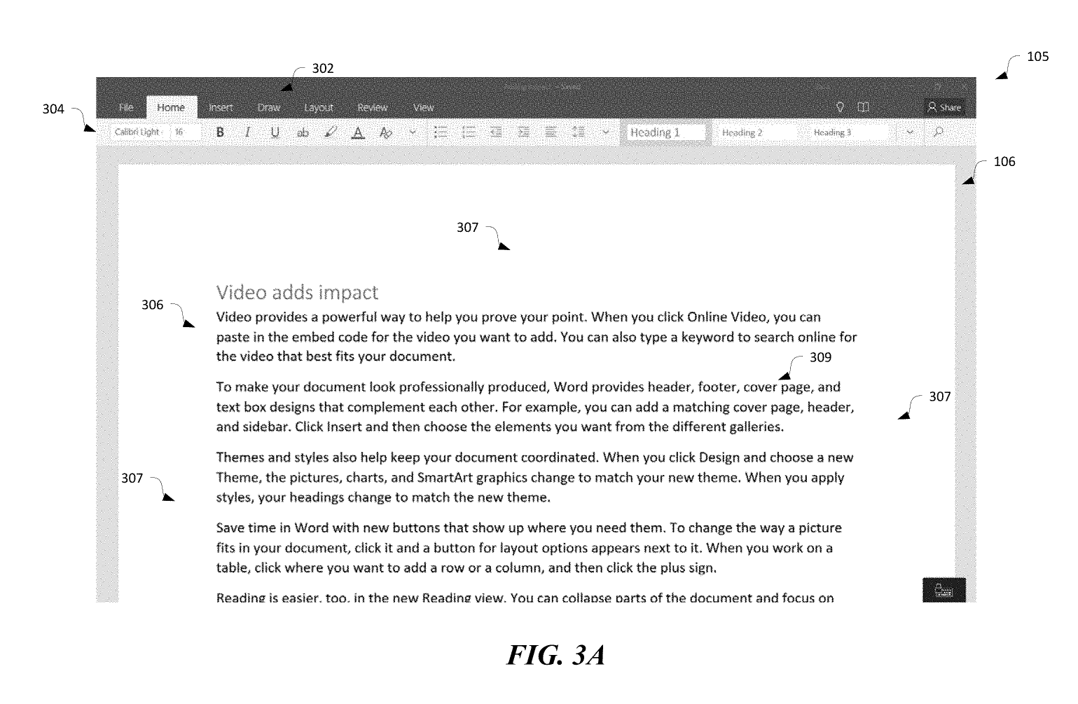

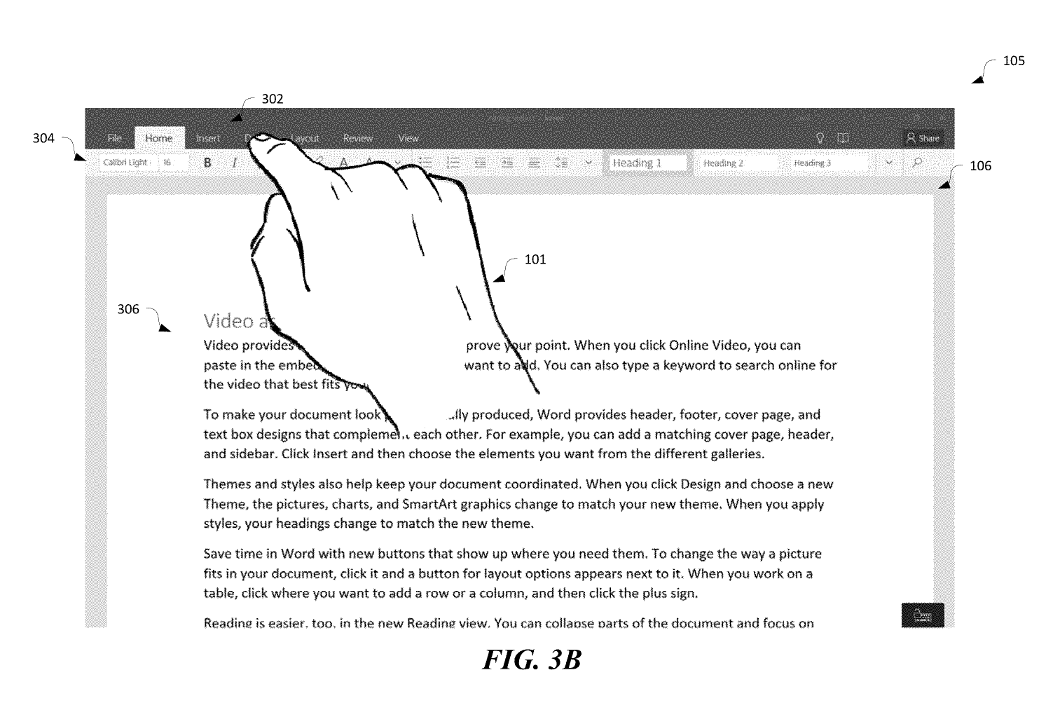

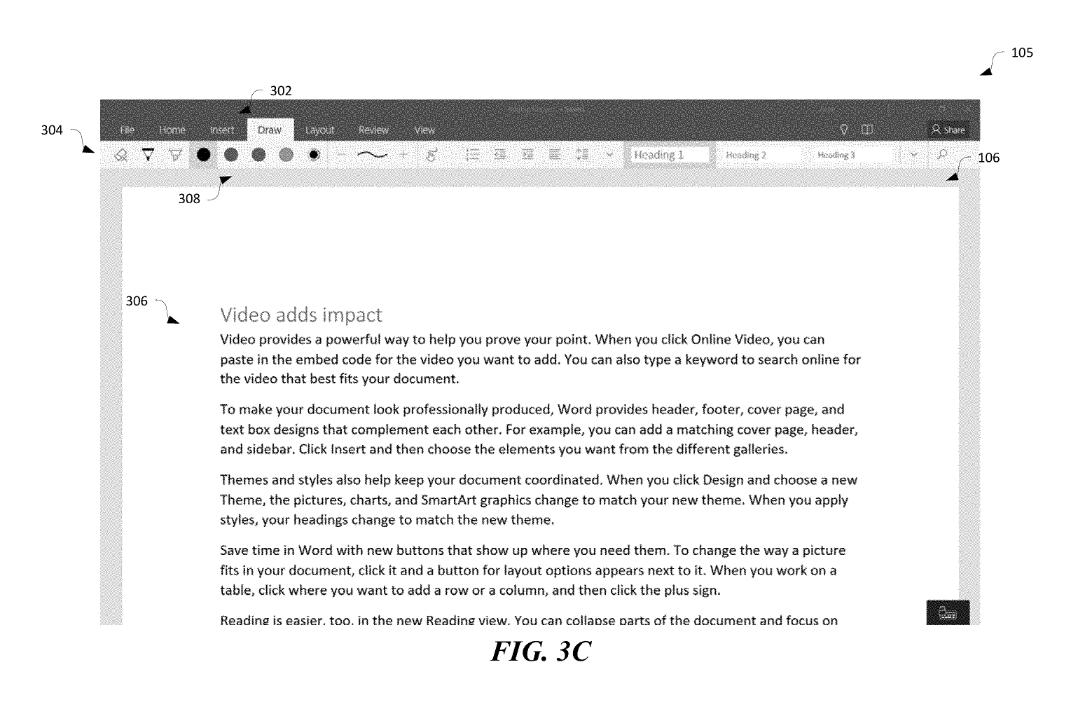

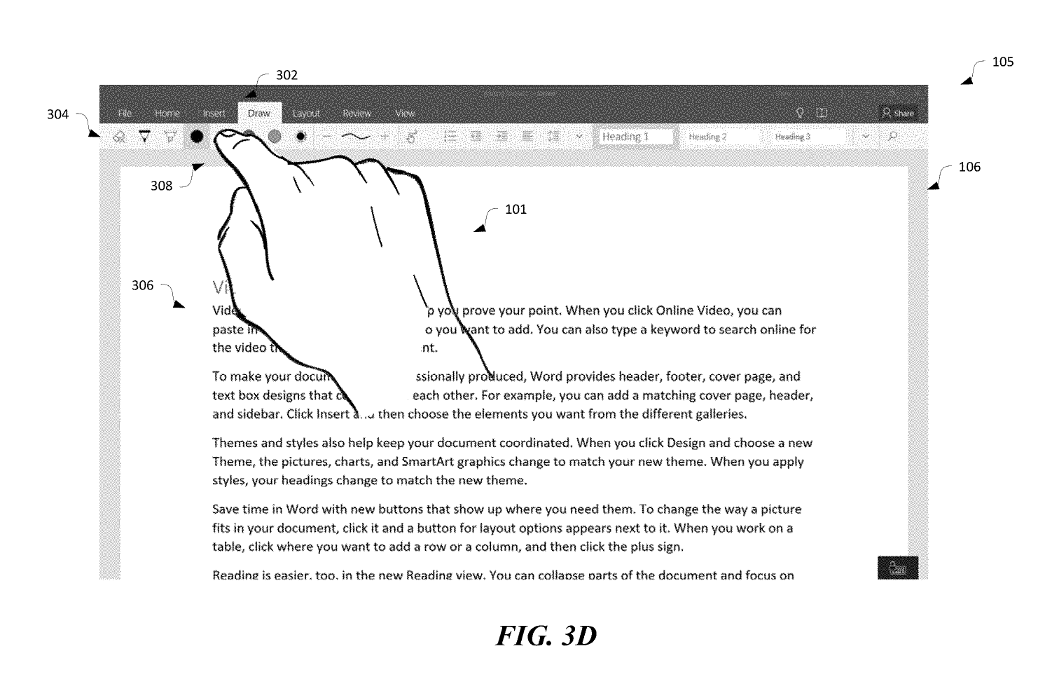

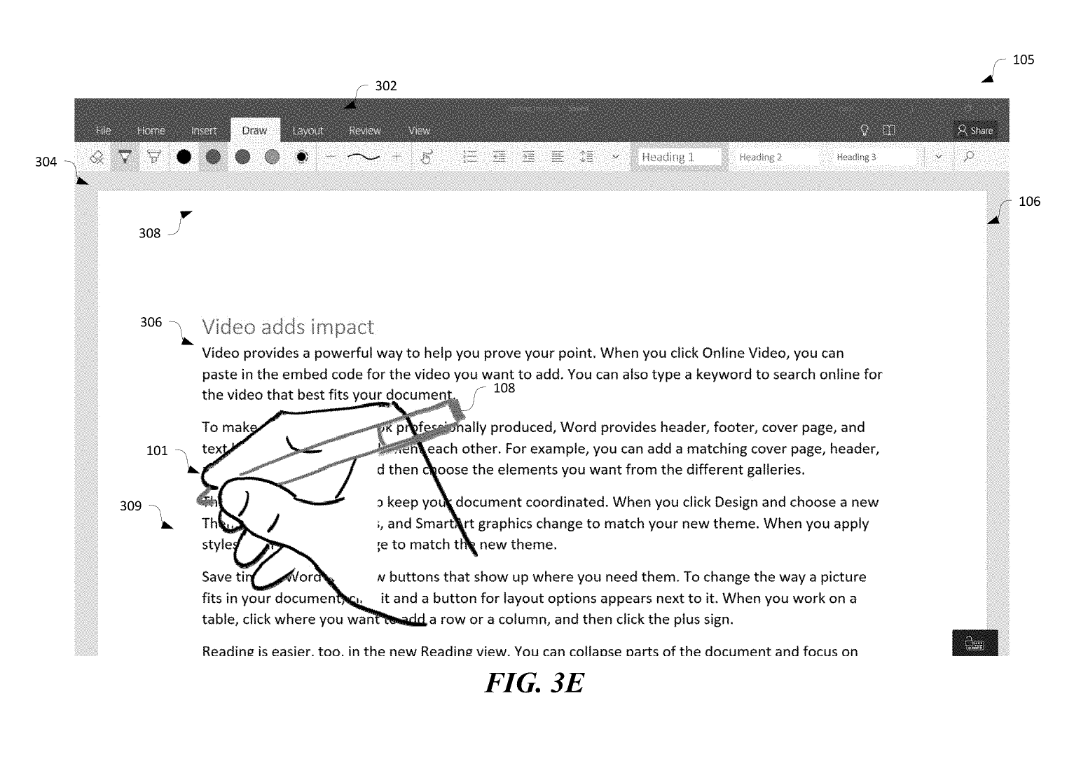

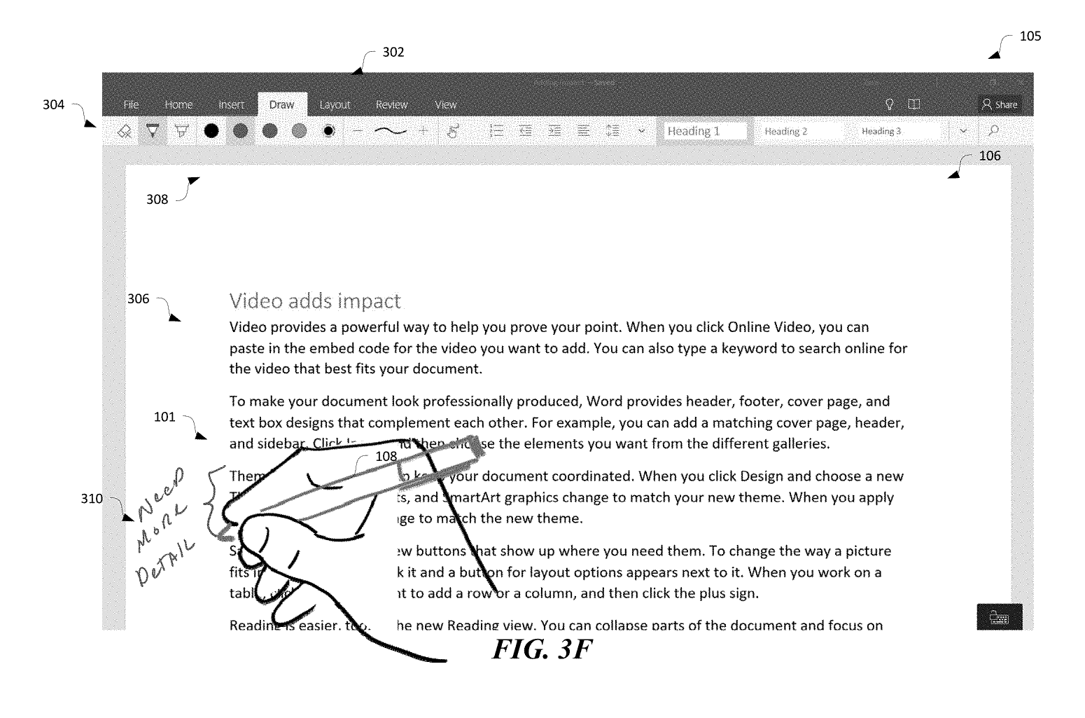

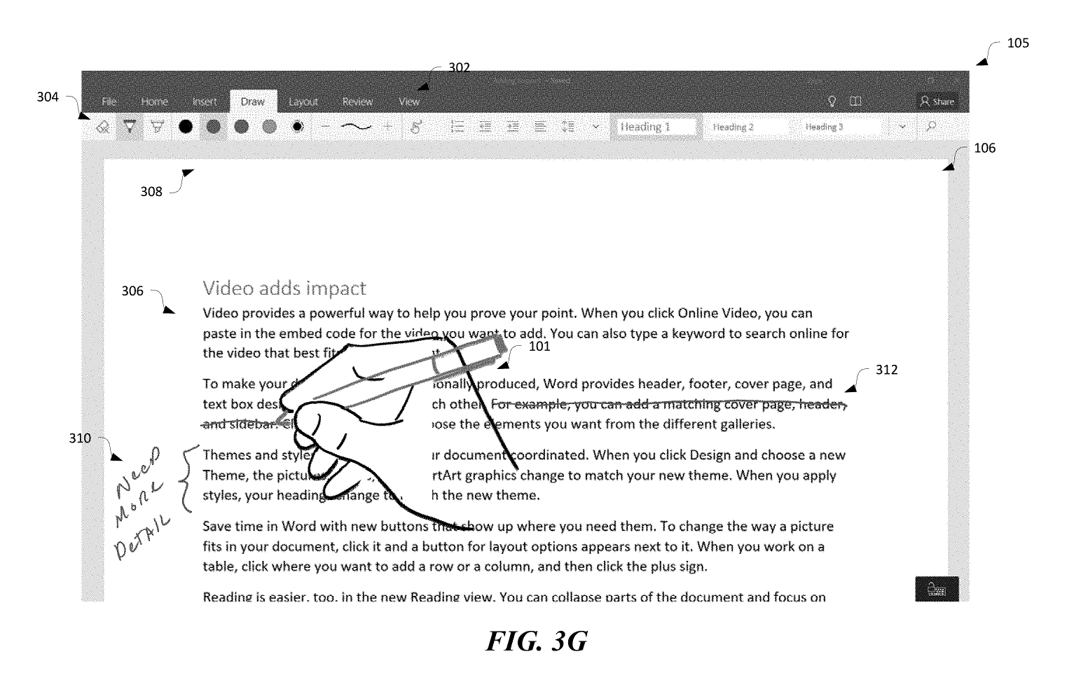

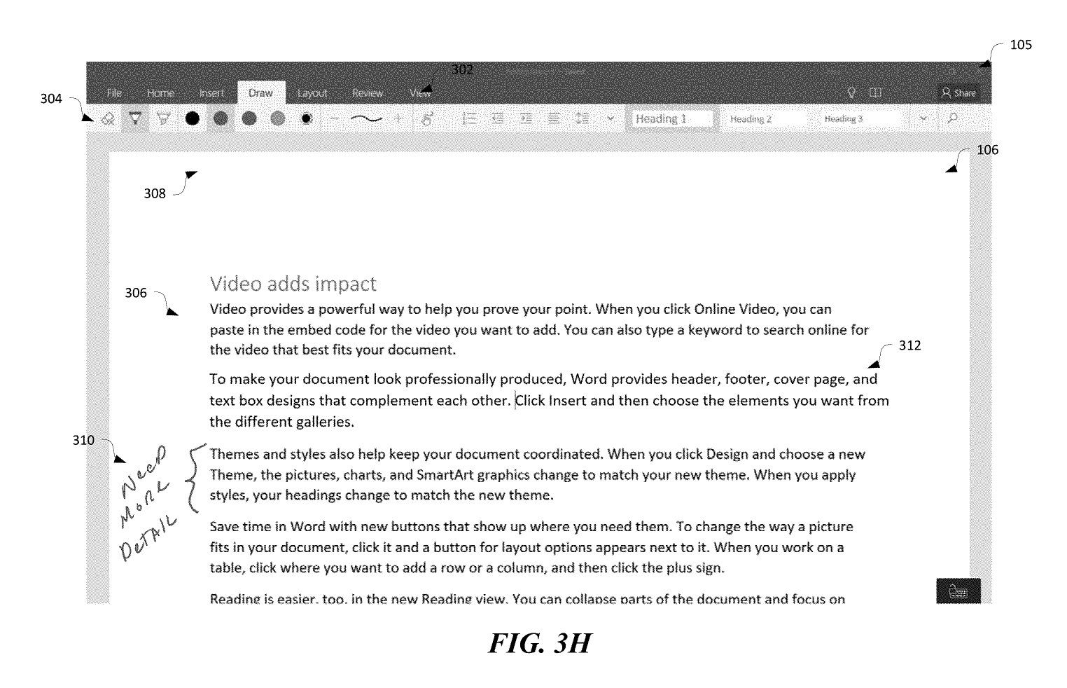

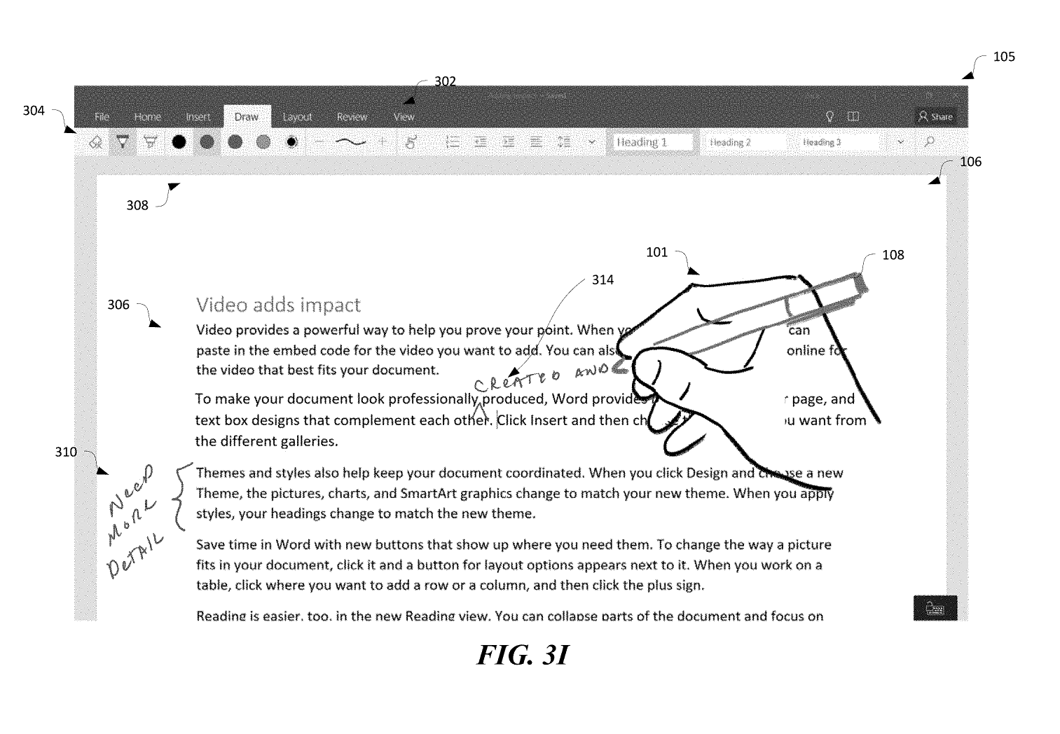

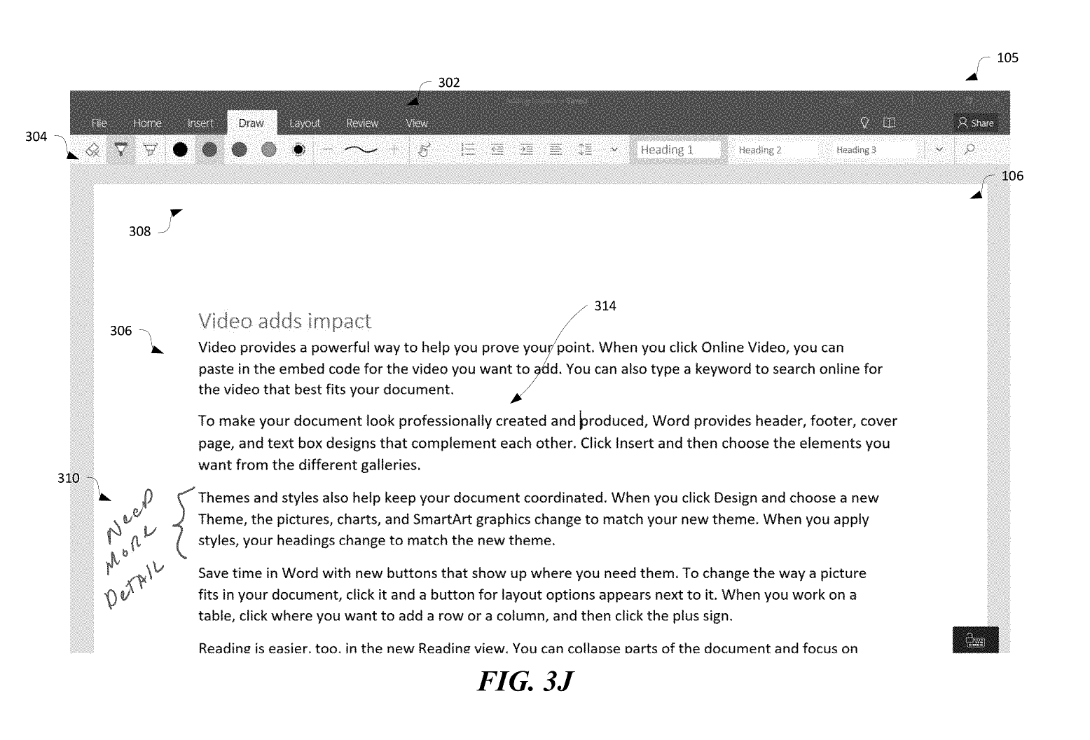

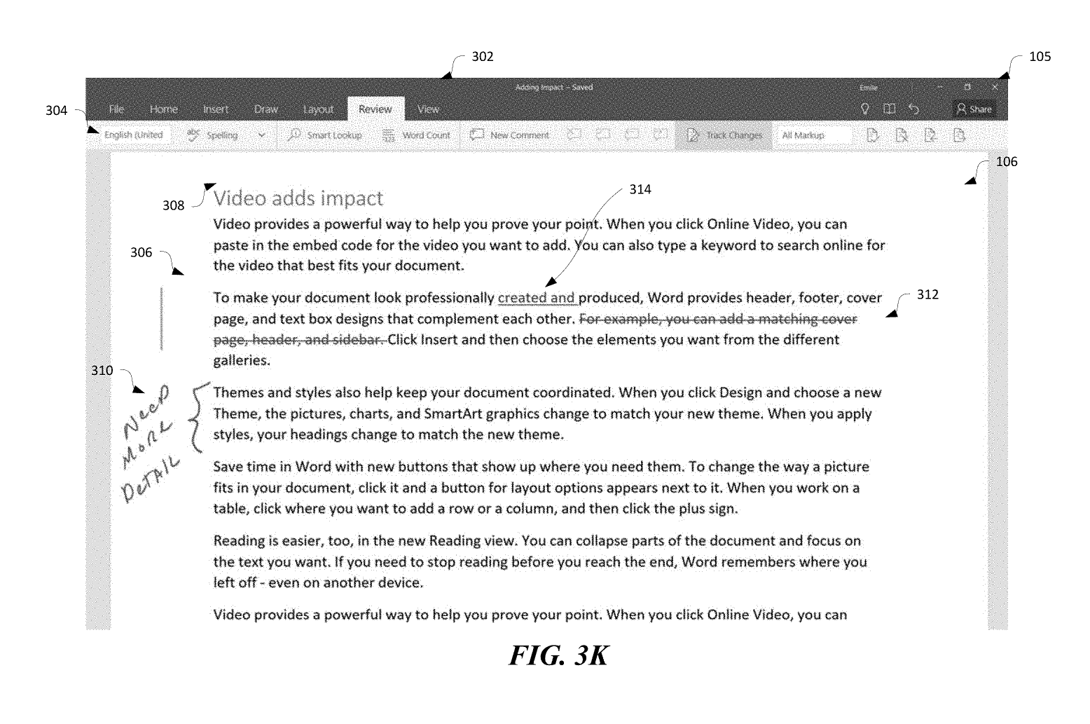

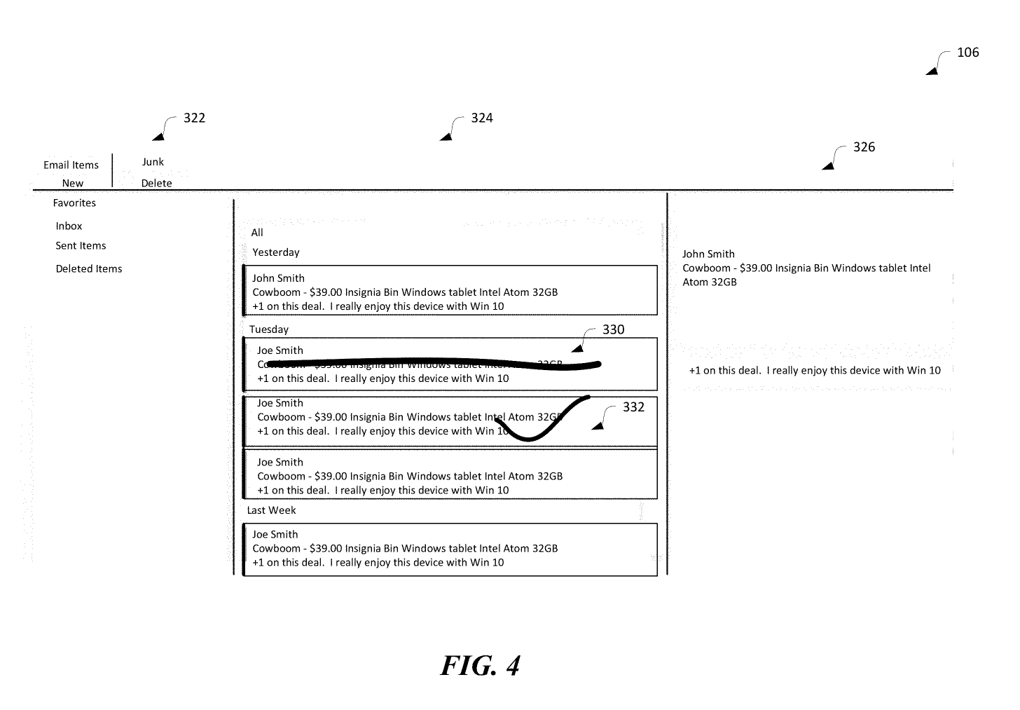

The ink recognition module 116 can be configured to recognize one or more editing operations 113 available or corresponding to a recognized gesture for the application 105. For example, the ink recognition module 116 can be configured to recognize that a strike-through gesture in a word processor corresponds to deleting a word, a line, a sentence, a selection, or other parts of the document, as described in more detail below with reference to FIGS. 3A-3K. In another example, the ink recognition module 116 can also be configured to recognize that a strike-through gesture in an email client can correspond to deleting an underlying email associated with the strike-through gesture, as described in more detail below with reference to FIG. 4. The ink recognition module 116 can also be configured to provide the recognized one or more editing operations 113 to the application 105.

In response to the editing operations 113 from the ink analyzer 107, the application 105 can edit or otherwise modify the underlying content by performing the one or more editing operations automatically or selectively. The application 105 can then output the edited content 115 to the rendering engine 109. As shown in FIG. 2, the rendering engine 109 can be configured to render the edited content 115 received from the application 105 on the user interface 106 on the computing device 102. In certain embodiments, the rendered edited content 115 can appear as underlying content without the digital ink 110 associated with the performed one or more editing operations. In other embodiments, the rendered edited content 115 can also include marks of tracked changes. In further embodiments, the rendering engine 109 can render the edited content 115 in other suitable manners.

In operation, the application 105 executing on the computing device 102 can receive digital ink 110 having one or more strokes from the user 101 via the user interface 106. The application 105 can then forward the digital ink 110 to the ink analyzer 107 to determine whether the digital ink 110 corresponds to one or more editing marks with corresponding editing operations 113 or to other types of annotations. In response to receiving the digital ink 110, the categorization module 112 can categorize the received digital ink 110 as editing marks, comments, or other suitable categories of annotation. If the received digital ink 110 is categorized as editing marks, the gesture engine 114 can then determine whether the digital ink 110 corresponds to one or more gestures. The gesture engine 114 can then forward the recognized gestures to the ink recognition module 116 which in turn can determine one or more editing operations 113 available or corresponding to the recognized gestures.

The ink recognition module 116 can then forward the determined one or more editing operations 113 to the application 105, which in turn can modify the underlying content of the document by performing the one or more of the editing operations 112 automatically or selectively. The application 105 can then forward the edited content 115 to the rendering engine 109, which in turn renders the edited content 115 on the user interface 106 of the application 105 on the computing device 102. Example operations of the foregoing components of the computing device 102 implemented in a word processor are described in more detail below with reference to FIGS. 3A-3K. Example operations of the foregoing components of the computing device 102 implemented in an email client are described in more detail below with reference to FIG. 4.

FIGS. 3A-3K are example user interfaces 106 illustrating operations suitable for the components of the computing device 102 shown in FIGS. 1 and 2 as implemented in a word processor application. As shown in FIG. 3A, the application 105 can include a user interface 106 can include a menu bar 302, a format bar 304, and underlying content 306 in a content area 309 within margins 307 surrounding the content area 309. In the illustrated embodiment, the underlying content 306 is shown as a text document with multiple paragraphs. In other embodiments, the underlying content 306 can also include embedded digital images, video recordings, voice recordings, digital animations, or other suitable types of content.

As shown In the illustrated embodiment of FIG. 3B, a user 101 can choose a “Draw” menu item on the menu bar 302 to in order to provide digital ink 110 (FIG. 2) to the user interface 106. In other embodiments, the user 101 can choose an “Edit,” “Ink,” “Annotation,” or other suitable types of menu items to provide the digital ink 110 in an annotation mode, editing mode, or other suitable modes. In response to receiving the user's selection of the menu item, as shown in FIG. 3C, multiple color selections 308 and drawing or annotation options can be displayed on the format bar 106 in the user interface 106. For example, the drawing options can include drawing as a pen, a pencil, a highlighter, or an eraser. In other embodiments, the drawing options can include think strokes, thin strokes, or other suitable drawing selections.

As shown in FIG. 3D, the user 101 can then select, for instance, “red” as an input color to the user interface 106 by pressing one of the color selections 308. As shown in FIG. 3E, the user 101 can then use a pointing device 108 (shown in FIG. 3E as a stylus for illustration purposes) to provide the digital ink 110 (FIG. 2) to the user interface 106. In the illustrated embodiment of FIG. 3F, the user 101 handwrites a comment 310 on a margin 309 of the document (i.e., “need more detail”). In response, the application 105 (FIG. 2) can categorizes the input as a comment and save the input as a graphical image to the document. In other embodiments, the application 105 can also be configured to automatically convert the comment 310 as a textual comment included with the underlying content 306 of the document.

As shown in FIG. 3G, the user 101 can also provide another input to the document, for instance, a strike-through mark 312 across the sentence “for example, you can add a matching cover page, header, and sidebar.” In response, the computing device 102 can categorize the provided digital ink 110 is related to an editing mark, recognizes the gesture as a strike-through, and provide a corresponding available operation as a deletion operation to the application 105. As shown in FIG. 3H, the application 105 can then delete the foregoing sentence with the strike-through from the underlying content of the document, and the rendering engine 109 (FIG. 2) can render the edited content 115 on the user interface 106.

As shown in FIG. 3I, the user 101 can also provide a further input by drawing an insertion mark 314 after the word “professionally” and handwriting an associated phrase, i.e., “created and” above the insertion mark. In response, the computing device 102 can categorize and recognize the insertion symbol and related text, i.e., “created and,” and automatically inserting the foregoing text string into the underlying content of the document to be rendered by the rendering engine 109 on the user interface 106, as shown in FIG. 3J. In certain embodiments, the foregoing editing operations can be tracked, and the tracked changes can be shown in the document, as shown in FIG. 3K. Even though the foregoing editing operations are described as being applied automatically, in other embodiments, the available one or more recognized editing operations 113 can also be outputted to the user 101 via, for example, a pop-up balloon or other suitable user interface elements. The user 101 can then select to apply or dismiss one or more of the suggested editing operations 113. In response to a user selection, one or more editing operations 113 selected by the user 101 can then be applied. In further embodiments, the editing operations 113 can be categorized into a first group that can be automatically applied and a second group that require user selection and/or confirmation.

FIG. 4 is another example user interface 106 illustrating certain operations suitable for the computing device 102 in FIGS. 1 and 2 as implemented as an email client. For example, as shown in FIG. 4, the user interface 106 can include a folder pane 322, an email pane 324, and a detail pane 326. In the illustrated embodiment, the application 105 (FIG. 2) can recognize that the user 101 (FIG. 1) provides a first gesture (i.e., strike through) on a first email 330 and a second gesture (i.e., a check mark) on a second email 332. In response, the application 105 can correlate the first gesture with, for instance, deletion of the related first email and automatically delete the first email 330, for example, by moving the first email to the “Deleted Items” folder. The application 105 can also correlate the second gesture with, for instance, “marked as read” and automatically mark the second email 322 as read. In other embodiments, the application 105 can also seek confirmation for the foregoing or other suitable operations before performing such operations.

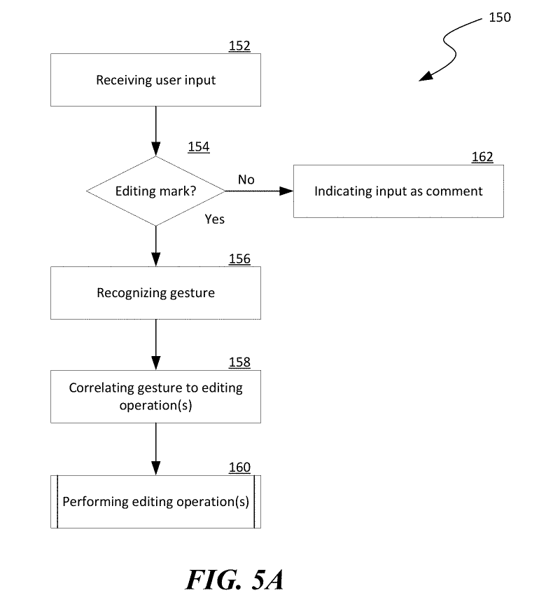

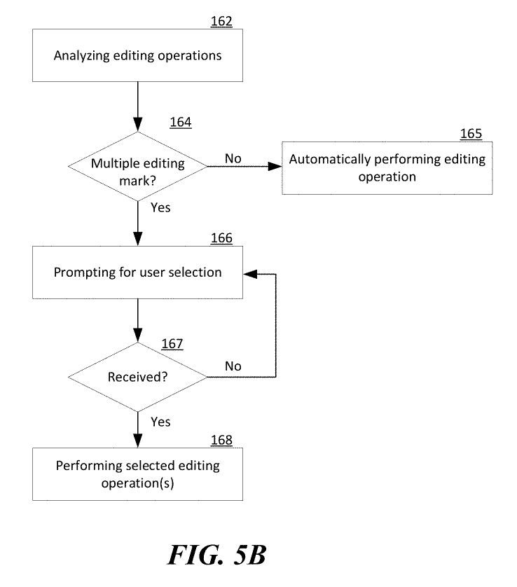

FIG. 5A is a flowchart illustrating a method 150 of smart annotation of a document in accordance with embodiments of the disclosed technology. Even though the method 150 is described below as implemented in the computing device 102 of FIGS. 1 and 2, in other embodiments, the method 150 can also be implemented in other computing devices and/or systems.

As shown in FIG. 5A, the method 150 can include receiving a user input as digital ink 110 (FIG. 2) to a document displayed in a user interface 106 (FIG. 2) on the computing device 102 (FIG. 2). In certain embodiments, the user 101 (FIG. 2) can provide the user input using the pointing device 108. In other embodiments, the user 101 can also provide the user input via voice recognition, a keyboard, a mouse, or other suitable types of input device.

The method 150 can then include a decision stage 154 to determine whether the received user input is related to one or more editing marks. In one embodiment, the user input can be categorized into notes, comments, editing marks, explanations, or other suitable categories using, for example, the categorization component 112 in FIG. 2 based on, for example, a location, timing, or other suitable characteristics of the user input. In other embodiments, the user input can be categorized and/or determined via user indication or other suitable techniques.

In response to determining that the user input is not related to an editing mark, the method 150 includes indicating that the user input is a comment, note, explanation, or other suitable categories of information to be stored in as metadata or other suitable data in the document. In response to determining that the user input is related to an editing mark, the method 150 includes recognizing one or more gestures related to the user input by, for example, searching a gesture database or via other suitable techniques. The method 150 can then include correlating the one or more recognized gestures to one or more editing operations at stage 158. In one embodiment, a gesture can be related to a single editing operation. For example, a strike-through can be related to a deletion operation. In other embodiments, a gesture can be related to multiple editing operations. For example, a long tap can be related to operations of copy, cut, and paste.

As shown in FIG. 5A, the method 150 can further include performing one or more of the editing operations at stage 160. In certain embodiments, the one or more editing operations can be automatically performed in response to the user input received at stage 152. In other embodiments, the one or more editing operations can be performed selectively, one example of which is described in more detail below with reference to FIG. 5B.

As shown in FIG. 5B, the operations of performing the one or more editing operations can include analyzing whether the gesture can potentially correspond to multiple editing operations at stage 162. In one embodiment, analyzing the gesture can include performing a search of a gesture database to discover all potential editing operations. In other embodiments, analyzing the gesture can also include correlating the gesture to one or more editing operations based on previous user inputs and associated editing operations.

At stage 164, in response to determining that the gesture does not correspond to multiple editing operations, the operations include automatically performing the editing operation to the underlying content of the document at stage 165. On the other hand, in response to determining that the gesture corresponds to multiple potential editing operations, the method includes outputting the multiple potential editing operations to the user and prompting the user for a selection of one or more from the outputted editing operations at stage 166. The method can then include another decision stage 167 to determine whether a user selection is received. In response to receiving a user selection of one or more of the editing operations, the method includes performing the selected one or more editing operations at stage 168. In response to not receiving a user selection, the method reverts to prompting for a user selection at stage 166.

FIG. 6 is a schematic diagram illustrating example hardware components suitable for the computing device 102 in FIG. 1. In a very basic configuration 202, computing device 102 can include one or more processors 204 and a system memory 206. A memory bus 208 may be used for communicating between processor 204 and system memory 206.

Depending on the desired configuration, the processor 204 may be of any type including but not limited to a microprocessor (ρP), a microcontroller (μC), a digital signal processor (DSP), or any combination thereof. The processor 204 may include one more levels of caching, such as a level one cache 210 and a level two cache 212, a processor core 214, and registers 216. An example processor core 214 may include an arithmetic logic unit (ALU), a floating point unit (FPU), a digital signal processing core (DSP Core), or any combination thereof. An example memory controller 218 may also be used with processor 204, or in some implementations memory controller 218 may be an internal part of processor 204.

Depending on the desired configuration, the system memory 206 may be of any type including but not limited to volatile memory (such as RAM), non-volatile memory (such as ROM, flash memory, etc.) or any combination thereof. The system memory 206 can include an operating system 220, one or more applications 222, and program data 224. This described basic configuration 202 is illustrated in FIG. 2 by those components within the inner dashed line.

The computing device 102 may have additional features or functionality, and additional interfaces to facilitate communications between basic configuration 202 and any other devices and interfaces. For example, a bus/interface controller 230 may be used to facilitate communications between the basic configuration 202 and one or more data storage devices 232 via a storage interface bus 234. The data storage devices 232 may be removable storage devices 236, non-removable storage devices 238, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 206, removable storage devices 236, and non-removable storage devices 238 are examples of computer readable storage media. Computer readable storage media include storage hardware or device(s), examples of which include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which may be used to store the desired information and which may be accessed by computing device 102. Any such computer readable storage media may be a part of computing device 102. The term “computer readable storage medium” excludes propagated signals and communication media.

The computing device 102 may also include an interface bus 240 for facilitating communication from various interface devices (e.g., output devices 242, peripheral interfaces 244, and communication devices 246) to the basic configuration 202 via bus/interface controller 230. Example output devices 242 include a graphics processing unit 248 and an audio processing unit 220, which may be configured to communicate to various external devices such as a display or speakers via one or more A/V ports 222. Example peripheral interfaces 244 include a serial interface controller 224 or a parallel interface controller 226, which may be configured to communicate with external devices such as input devices (e.g., keyboard, mouse, pen, voice input device, touch input device, etc.) or other peripheral devices (e.g., printer, scanner, etc.) via one or more I/O ports 228. An example communication device 246 includes a network controller 260, which may be arranged to facilitate communications with one or more other computing devices 262 over a network communication link via one or more communication ports 264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 102 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 102 may also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

1. A method for editing a document on a computing device, comprising:
receiving a user input to a document from a user utilizing a stylus, a pen, or a finger of the user, the user input including an annotation of the document having underlying content;
determining whether the annotation is related to an editing mark applicable to the underlying content of the document;
in response to determining that the annotation is related to an editing mark,
correlating the received user input to a gesture;
determining whether the correlated gesture corresponds to one or more editing operations applicable to the displayed underlying content of the document; and
in response to determining that the correlated gesture corresponds to at least one editing operation applicable to the displayed underlying content of the document, performing the at least one editing operation to the displayed underlying content in the document.

2. The method of claim 1 wherein performing the at least one editing operation to the displayed underlying content in the document includes performing the at least one editing operation to a portion of the displayed underlying content in the document based on a location of the received user input relative to the displayed underlying content.

3. The method of claim 1 wherein correlating the received user input to a gesture includes:
categorizing the received user input as one of a comment or an editing mark;
in response to categorizing the received user input as an editing mark, correlating the received user input to a gesture; and
in response to categorizing the received user input as a comment, causing the user input to be saved as a digital image associated with the document.

4. The method of claim 1 wherein receiving the user input includes:
receiving a user selection to enter one or more annotations to the displayed document; and
in response to receiving the user selection, recognizing the received user input as one or more annotations to the displayed document.

5. The method of claim 1 wherein receiving the user input includes:
receiving a user selection to enter one or more annotations to the displayed document; and
in response to receiving the user selection, recognizing the received user input as digital ink associated with the displayed document.

6. The method of claim 1 wherein:
the document includes a margin area and a content area;
the underlying content is displayed in the content area; and
determining whether the annotation is related to an editing mark includes:
determining whether a location of the received user input is in the margin area or in the content area; and
in response to determining that the location of the received user input is in the margin area, indicating that the received user input is a comment.

7. The method of claim 1 wherein:
the document includes a margin area and a content area;
the underlying content is displayed in the content area; and
determining whether the annotation is related to an editing mark includes:
determining whether a location of the received user input is in the margin area or in the content area; and
in response to determining that the location of the received user input is in the content area, indicating that the received user input is an editing mark.

8. The method of claim 1 wherein:
in response to determining that the correlated gesture corresponds to at least one editing operation,
determining whether the correlated gesture corresponds to more than one editing operation; and
in response to determining that the correlated gesture corresponds to a single editing operation, performing the single editing operation automatically.

9. The method of claim 1 wherein:
in response to determining that the correlated gesture corresponds to at least one editing operation,
determining whether the correlated gesture corresponds to more than one editing operation; and
in response to determining that the correlated gesture corresponds to multiple editing operations,
prompting the user to select one or more of the editing operations; and
performing the selected one or more editing operations in response to receiving a user selection.

10. A computing device, comprising:
a processor;
an input/output device; and
a memory containing instructions executable by the processor to cause the processor to perform a process comprising:
receiving, via the input/output device, digital ink to a document displayed on the input/output device, the document having underlying content in addition to the received digital ink;
in response to receiving the digital ink, determining whether the digital ink is related to an editing mark applicable to the underlying content of the displayed document;
in response to determining that the received digital ink is related to an editing mark,
determining one or more editing operations corresponding to the editing mark, the one or more editing operations being applicable to the underlying content of the displayed document; and
performing at least one of the one or more editing operations to the underlying content in the displayed document based on the received digital ink without manual editing of the underlying content of the document.

11. The computing device of claim 10 wherein performing at least one of the one or more editing operations includes performing the at least one of the one or more editing operations to a portion of the displayed underlying content in the document based on a location of the received annotation relative to the displayed underlying content.

12. The computing device of claim 10 wherein:
the digital ink is related to a strike-through editing mark; and
performing at least one of the one or more editing operations includes deleting a portion of the underlying content overlapping the strike-through editing mark without manual editing of the underlying content of the document.

13. The computing device of claim 10 wherein:
the digital ink includes an insertion mark and an associated phase; and
performing at least one of the one or more editing operations includes inserting the associated phrase into the underlying content at a location associated with the insertion mark without manual editing of the underlying content of the document.

14. The computing device of claim 10 wherein receiving the digital ink includes:
receiving a user selection to enter the digital ink to the displayed document; and
in response to receiving the user selection, recognizing subsequent user input as digital ink associated with the displayed document.

15. The computing device of claim 10 wherein:
the document includes a margin area and a content area;
the underlying content is displayed in the content area; and
determining whether the digital ink is related to an editing mark includes:
determining whether a location of the received digital ink is in the margin area or in the content area; and
in response to determining that the location of the received digital ink is in the margin area, indicating that the received digital ink is a comment.

16. The computing device of claim 10 wherein:
the document includes a margin area and a content area;
the underlying content is displayed in the content area; and
determining whether the digital ink is related to an editing mark includes:
determining whether a location of the received digital ink is in the margin area or in the content area; and
in response to determining that the location of the received digital ink is in the content area, indicating that the received digital ink is an editing mark.

17. A method for editing a document on a computing device, comprising:
receiving a user input representing an annotation to underlying content of a document displayed in an application executed on the computing device, the application being in an annotation mode, wherein the received annotation is not a part of the underlying content;
in response to receiving the annotation, determining whether the annotation is related to an editing mark applicable to the underlying content of the document;
in response to determining that the received annotation is related to an editing mark,
determining one or more editing operations corresponding to the editing mark, the one or more editing operations being applicable to a portion of the underlying content associated with a location of the annotation in the displayed document; and
performing at least one of the one or more editing operations to the underlying content in the displayed document based on the received annotation without exiting the annotation mode of the application.

18. The method of claim 17, further comprising:
receiving a user selection to enter the annotation mode of the application; and
in response to the received user selection, providing annotation options to the user on the computing device.

19. The method of claim 17 wherein determining whether the annotation is related to an editing mark includes categorizing the received annotation as one of a comment or an editing mark.

20. The method of claim 17 wherein determining whether the annotation is related to an editing mark includes categorizing the received annotation as one of a comment or an editing mark, and wherein the method further comprising in response to categorizing the annotation as a comment, storing the received annotation on a layer of the document different than another layer containing the underlying content.
